(19) United States
(12) Patent Application Publication
(10) Pub. No.: US 2005/0107945 A1
(43) Pub. Date: May 19, 2005

(54) Method for determining a travel time

(76) Inventors: Andreas Hiller, Stuttgart (DE); Peter Konhaeuser, Stuttgart (DE)

Correspondence Address: Davidson Davidson & Kappel, 485 Seventh Avenue, 14th Floor, New York, NY, 10018, US

(21) Appl. No.: 10/500,651

(22) PCT Filed: Nov. 14, 2002
(86) PCT No.: PCT/EP02/12744

(30) Foreign Application Priority Data
Jan. 15, 2002 (DE) 10201106.6

(51) Int. Cl. G01C 21/26

(52) U.S. Cl. 701/201; 701/204

(57) ABSTRACT

A method for determining a journey time is proposed for a journey route for a following vehicle which is traveling in a sequence of vehicles. This method comprises the steps: journey profile data is registered by at least one vehicle traveling ahead in the sequence, the journey profile data comprising at least one travel time or data from which travel time can be determined, for a route component between two positions on the journey route, and the journey time for a route comprising the route component is calculated from the journey profile data, journey profile information which comprises the journey profile data or the journey time being transmitted to at least one receiving following vehicle using vehicle-to-vehicle communication by at least one transmitting vehicle traveling ahead. In order to determine the journey time, the journey information of a plurality of vehicles is preferably transferred to following vehicles by forming a transmission chain.

The invention relates to a method for determining a journey time for an intended journey route or a journey route section of a vehicle, preferably of a motor vehicle, the journey time being determined in a decentralized way. Journey time is understood here to be an expected duration for a specific journey route to be travelled along. A time which is actually required by a vehicle is referred to as travel time.

For the driver of a vehicle, the current journey time for a journey route is a very significant item of information relating to the route ahead of him. This journey time is also a basic item of information for determining an optimum plan for a journey route as is carried out by vehicle navigation devices. Other information on the journey route, for example information on traffic congestion, is merely used to estimate the journey time.

The following methods are currently used to calculate journey times:
information from digital maps with average speeds specific to types of roads
characteristic curve forecasts with empirical travel time profiles on routes as a function of the time of day and the day of the week
evaluation of messages relating to traffic congestion, for example from a traffic information channel (Traffic Message Channel TMC)
evaluation of speed measurements on loops or from data on flowing traffic (Floating Car Data (FCD))
transfer of travel times from FCD to a control center
reconstruction of the traffic situation from measurement data and immediate evaluation of the data in a simulation (online simulation).

U.S. Pat. No. 5,933,100 discloses a method for forecasting a future journey time for a vehicle up to an intended destination. In this method, vehicles which are moving in the region of a road map database transfer their travel times, respectively required for specific road segments, to a control center. As a result, the road map database is supplemented with currently expected journey times. A vehicle driver who requires the expected journey time to a specific destination can be provided by the control center with a journey time forecast on the basis of this additional map information, or determine the forecast himself from the data made available by the control center. A disadvantage with the method is that the journey time forecast is determined by a control center or at least the data which is necessary to determine the journey time has to be made available by the control center.

U.S. Pat. No. 6,150,961 discloses a method in which vehicles transmit information relating to their position and speed to adjacent vehicles. Furthermore, warnings about delays on the rest of the journey route in order to be able to estimate future problems on the rest of the journey route are transmitted. However, the document does not disclose a method for reliably forecasting a future journey time for a vehicle up to an intended destination.

The following restrictions are disadvantageous in the traffic information systems according to the prior art:
When a journey time is determined, a control center is always involved, said control center collecting data, evaluating it and then transmitting the information acquired in this way onwards to the vehicles. As a result, an operator is required for the control center and costs are incurred for the operation of the control center.
Data which is not relevant for the current travel route is transmitted to the vehicles.
The up-to-dateness of the data is not ensured when it is received in a vehicle. For example, delays may arise as a result of the processing of the input information in the control center.
The journey time is estimated by reference to indices such as classes of road or messages about traffic congestion, but is not measured directly, and is therefore imprecise.

The invention is based on the object of making available a method for determining a journey time, which method avoids the disadvantages of the prior art and in particular takes into account the current traffic situation on an intended journey route without the involvement of a traffic control center.

The object is achieved in accordance with the invention using the method according to the independent claim. Particular embodiments are the subject-matter of the dependent claims.

The method according to the invention is based on the idea that, when there is a sequence of vehicles which are traveling in the same direction on a journey route, the vehicles which are traveling ahead of a vehicle driver who requires journey time information can determine the respectively most up-to-date travel times on the journey route. The respectively most up-to-date journey time can be determined from this. The journey time information generally comprises the respective vehicle's own stored journey profile, that is to say the distance covered calculated against time, that is to say a relationship between the travel time and positions on the journey route. This information will be referred to below as journey profile data. This journey profile data can be transferred to vehicles following in the sequence using vehicle-to-vehicle communication, as a result of which the respectively most up-to-date expected journey time on the journey route can be made available to the vehicle driver requiring the journey time information.

Below, the vehicle receiving the journey time information will be referred to as representative of the respective driver who requires journey time information. Furthermore, in each case travel times to be transferred will be referred to. Here, of course, it is also possible to transfer data which is suitable for determining this travel time. For example, in place of the travel time between positions on a route, it is possible to transfer a travel speed, in which case the corresponding travel time can be determined on condition that this speed between the positions on the route is constant, for example.

The vehicle-to-vehicle communication is a communication concept in which vehicles exchange data with other vehicles in their surroundings in a decentralized fashion. The communication is preferably carried out using short-range transmission technologies or using selective addressing of vehicles in the surroundings using relatively long-range technologies, for example using mobile phone networks (Global System for Mobility Communication (GSM)). The transmission of information using mobile phone technology does indeed take place via a telephone center, but this corresponds to the inventive concept of direct communication between the vehicles as the journey profile data is not processed further in terms of content as would be the case if the data were transmitted via a traffic control center. Even when short-range transmission technology is used, information can be transferred over larger distances than the respective range if the information is passed on between a plurality of vehicles in an information transmission chain. By setting up relatively long communications chains, it is possible to determine a journey time along a journey route in accordance with the invention. In order to carry out the method according to the invention, it is not absolutely necessary for all the vehicles on the respective journey route for which a journey time is determined to be equipped with a technology for vehicle-to-vehicle communication. It is also possible for vehicles which do not have such technology and are not involved in the method according to the invention to travel between the communicating vehicles. Furthermore, vehicles which do not register their own journey profile data can participate in the communications chain as intermediaries.

According to the invention, in order to determine a journey time for a journey route for a vehicle which follows in a sequence of vehicles (a following vehicle), journey profile data is registered using at least one vehicle traveling ahead in the sequence. The journey profile data comprises at least one travel time or data from which the travel time can be determined, for a route component between two positions on the journey route. The positions are route positions, that is to say positions of a vehicle on the journey route. These may be, for example, the instantaneous kilometer data for positions on the journey route at which the vehicle is located at specific times. The journey time is determined from the journey profile data, for at least one route comprising the route component. The journey time is therefore determined for at least one section from the journey route which lies ahead of the following vehicle requiring the journey information. The journey time can be determined here either in the vehicle determining journey profile data, from the journey profile data which has been determined and stored, or in a vehicle receiving the journey profile data, from the received journey profile data. In the former case, it is necessary for the vehicle registering journey profile data to be provided with information on the position, at a particular time, of the following vehicle for which the journey time is determined. The determination of the journey time is carried out here using a journey time determination module which is preferably embodied as an on-board computer. Furthermore, a storage module, which is preferably embodied as a component of the on-board computer, is provided in the vehicle in order to buffer journey profile data.

Journey profile information which comprises the journey profile data and/or the journey time is transmitted to at least one receiving following vehicle using vehicle-to-vehicle communication by at least one transmitting vehicle traveling ahead.

The positions on the journey route which determine the route component are preferably the current position of the following vehicle and a position on the future journey route of the following vehicle. The journey profile is preferably registered at least on a route which is of the order of magnitude of the range of the vehicle-to-vehicle communications device. The positions at which the travel times are registered preferably have fixed distances. This permits the data which is to be transferred using vehicle-to-vehicle communication to be reduced, and enables the journey time calculation to be simplified. If a vehicle which requires a journey time to be determined according to the invention is located between two route positions at which the travel times have been registered, the chronological journey profile for calculating the journey time is preferably approximated linearly. This means that a constant average speed between the route positions of the vehicle registering the corresponding travel times is assumed.

The transmission of journey profile data is preferably carried out by transmitting parameters of functions representing the journey profile data. Here, specific function parameters are determined using known methods by adaptation to the functional profile of the journey profile data, and transferred instead of the actual journey profile data. These are preferably parameters of a polygonal-like function profile. This preferred embodiment leads to an additional reduction in the quantity of data to be transmitted.

In the method according to the invention, a plurality of vehicles traveling in the sequence particularly preferably receive journey profile information from vehicles traveling ahead and transmit journey profile information, the vehicles forming a communications chain in such a way that at least parts of the journey profile information which are respectively received by the vehicles and/or overall travel times determined therefrom are transmitted by the receiving vehicles onwards to vehicles following in the sequence. Here, a time which is obtained by adding travel times is referred to as the overall travel time. The designation used in the present description therefore refers to a travel time which has been determined from travel times of at least some of the vehicles involved in the communications chain. If the vehicles on the journey route form such a communications chain in which journey profile information containing travel times is received by vehicles traveling ahead and transmitted to following vehicles, a currently expected travel time for a future journey route of any desired length can theoretically be calculated by adding times which have been transmitted to following vehicles in this way. In order to form such a communications chain, it is sufficient, given adequate traffic density, to transmit the stored journey profile data only a short distance, that is to say for example several hundred meters, upstream.

The journey profile information which is to be transmitted and which is transferred to following vehicles is preferably restricted to a specific radius around the transmitting or receiving vehicles. As a result, the quantity of data to be transmitted is limited. This radius can be defined, for example, by specifying a degree of chronological accessibility. For example, it is expedient to transmit journey profile data which relate to route sections which can be reached within two hours.

The journey profile information transmitted by the vehicles preferably contains at least one section overall journey time for at least one journey section which is determined by two journey section boundaries in each case. These journey section boundaries are the boundaries of defined route sections into which a road network is spatially divided. The positions of the section boundaries are known within the vehicles involved in the method. The position-determining system within the vehicles detects when the section boundaries are reached. Journey times are preferably determined for such entire sections and passed on as an overall travel time for the associated section. In one preferred embodiment of the method according to the invention, journey profile information relating to sections which are still to be travelled through in the journey profile, that is to say lie further ahead, are also transmitted to the following vehicles in addition to the journey profile information which is associated with the journey profile in the current section, i.e. the one which is being travelled through at a particular time. According to the invention, this information is transferred by vehicles traveling ahead of the vehicle which reaches the section boundary to the vehicle reaching the section boundary. The journey information transmitted by the vehicles then includes at least one section overall journey time for at least one journey section determined by two journey section boundaries in each case.

Timing of the transmission of the journey profile information is preferably coordinated. This coordination is achieved by triggering the transmission when specific events occur. The transmission of journey profile information is preferably triggered by the reception of journey profile information from vehicles traveling ahead and/or as a result of journey section boundaries being reached.

A further possible way of triggering the method according to the invention is for the transmission of the journey profile information to be triggered by the vehicles as a result of the reception of a journey information inquiry. A further preferred embodiment of the method according to the invention includes the transmission of such a journey information inquiry by a vehicle whose driver requires the journey time as far as a destination or the end of a section of a journey. The journey information inquiry is transmitted here by a vehicle to at least one vehicle traveling ahead in the sequence, and the vehicles traveling ahead in the sequence transfer the journey information inquiry onwards to further vehicles traveling ahead until the journey information inquiry has been transferred to a frontmost vehicle traveling ahead, which vehicle having already reached a destination which is specified in the journey information inquiry or a subsequent boundary of a journey section. The transmission back of the journey information by the frontmost vehicle is then triggered by the reception of the journey information inquiry. Bi-directional communication is therefore carried out. That is to say communication is carried out using vehicle-to-vehicle communication in the direction of travel, that is to say backwards in terms of the traffic flow and in the direction of the following vehicles, that is to say forwards in terms of the traffic flow. In this bi-directional journey time-determining method according to the invention, the calculation of the journey time as far as the destination contained in the journey information inquiry or the journey section end which is designated therein is preferably carried out in that the overall travel time as far as these locations is carried out by summing travel times of the vehicles involved in the communication. Here, the journey information inquiry includes a current vehicle position of the vehicle which is respectively transmitting the journey information inquiry. The journey profile information which is transferred to at least one following vehicle comprises an overall travel time between the current vehicle position and the destination or the boundary of the journey section. The overall travel time is calculated here by summing the travel times transmitted back from the frontmost vehicle traveling ahead to the vehicles which are involved in passing on the journey information inquiry.

The vehicles determine their position using a positioning system which is provided in the vehicle, for example a satellite-locating system, or determination of position using a mobile phone, preferably using the Global Positioning System (GPS). The accuracy of the method according to the invention is also determined here by the accuracy of the determination of position of the individual vehicles involved in the execution of the method according to the invention. The determination of the position can be improved using a digital map and map matching methods, that is to say methods in which the corresponding position on the map is determined for a vehicle position which has been measured. The travel times can be determined, for example, using a clock which is usually present in every vehicle.

If the road network, and thus the possible future journey routes, branch, the received journey profile information must be transmitted onwards for all the possible routes. Here, all the received and registered journey profile information which relates to routes lying within a radius is preferably passed on. The radius can be specified here as a distance, and the radius is preferably specified as a distance which can be reached in a specific time, for example two hours. With the exception of the preferred embodiment of the method according to the invention in which a vehicle transmits a journey information inquiry in order to obtain a journey time up to a specific destination, the entire journey profile information must always be passed on in the information chain. This is the only way that following vehicles can themselves determine a journey time to a desired destination from the received journey profile information.

The method according to the invention is preferably applied to journey routes with a traffic density which is not too low. Here, even in the case of vehicle-to-vehicle communication using a short-range transmission technology, it is possible to set up a communications chain over a long distance. The method according to the invention is therefore preferably applied on motorways or motorway-like roads reserved for motor vehicles. The method according to the invention can also be integrated into systems which are supported by a control center. Furthermore, systems with transmission and reception stations which are permanently installed on the journey routes can also be integrated into the method. The control center and/or the installed transmission and reception stations can be used here to span gaps in the traffic flow which lead to the communications chain being broken, in particular in the case of short-range transmission technologies. Here, the journey information which is received by the control center and/or by the permanently installed transmission and reception stations is transmitted onwards counter to the direction in which the vehicles transmitting the information are traveling. The intermediate connection of a control center and/or of installed transmission and reception stations, for example using a fault message, is preferably indicated to the vehicles involved in the method according to the invention.

The method according to the invention can preferably be used to determine an optimum journey route by selecting an alternative journey route for which a minimum journey time has been determined. Here, the journey times are determined for at least two alternative journey routes. The journey route with the shortest journey time determined according to the invention is then selected as an optimum journey route. In the case of the bi-directional journey time-determining method, the journey information inquiry must then contain data on the route profile for which the journey time is to be determined.

As a result of the method according to the invention, in particular the following advantages are obtained:
A traffic control center for determining the journey time is not required. The method functions in a decentralized way.
The journey time is determined on the basis of current information. It is ensured that no out-of-date information is included in the determination of the journey time.
The journey time is determined very precisely from selected information relating to the route in front of the vehicle as far as the destination.
In order to determine the journey time, a technology (FFK) is used which can also be used for other purposes in the vehicle. There is therefore no need for special supplementary equipment in the vehicle beyond the vehicle-to-vehicle communications device.
Vehicles preferably pass on only the journey times for the routes lying ahead of them, and the quantities of data to be transmitted are therefore very small. This journey time data is relevant for all the vehicles involved in the communications chain.

The present invention and preferred embodiments of the invention are described below without restricting their generality and with reference to the figures.

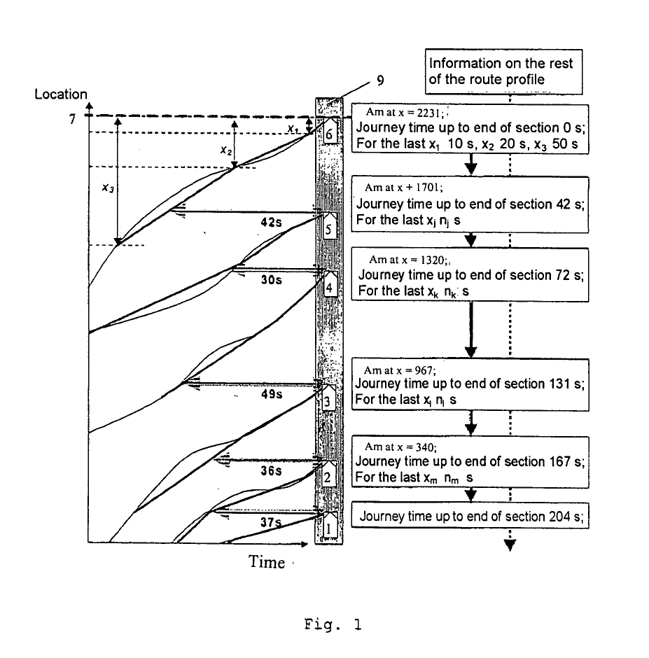

FIG. 1 shows the basic method according to the invention for the decentralized determination of the journey time on a route section with unidirectional communication.

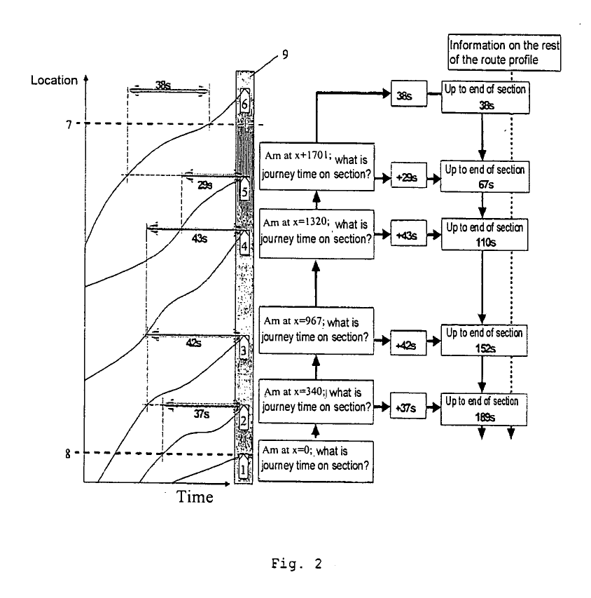

FIG. 2 shows the basic method according to the invention for the decentralized determination of the journey time on a route section with bi-directional communication.

FIG. 1 shows the basic method according to the invention for the decentralized determination of the journey time on a route section with unidirectional communication. This preferred embodiment of the method according to the invention dispenses with journey information inquiries and thus with communication between the vehicles in the direction of the route lying downstream. The method therefore comprises unidirectional vehicle-to-vehicle communication. The figure shows a sequence of six vehicles 1 to 6 involved in determining the journey time according to the invention, on a journey route 9. In the figure, there are no other vehicles located between the vehicles involved in the determination of the journey time. This is generally not necessarily the case. The journey time can be determined even if other vehicles which are not communicating according to the invention are traveling between the vehicles involved. To the left of the representation of the journey route, the journey profiles of individual vehicles are represented in a travel/time diagram. On the journey route there is a journey section boundary 7. The procedure of the communication between the vehicles is represented to the right of the journey route in the figure. The journey profile information relating to the rest of the route profile is always transferred in the direction of following vehicles from vehicles traveling ahead, i.e. is transferred to vehicles which are located upstream in the flow of traffic.

The transmission of the journey profile information takes place with triggering as a result of a section boundary being reached by a vehicle. In the figure the vehicle is the vehicle 6 which is illustrated at the top. This vehicle 6 transmits its journey profile information at least to the vehicle 5 which is following it and is involved in the execution of the method according to the invention. For example, the journey profile information comprises the travel times between the route positions x₁, x₂ and X₃ and the section end which has just been reached. The data of the journey profiles between these route positions is preferably interpolated linearly so that overall a polygonal profile is produced. This is illustrated in the travel/time diagram in the figure. As an alternative to linear interpolation, any other interpolation function with which the profile can be approximated using a suitable selection of function parameters is also possible. The vehicle 5 which receives the journey profile information is located at a position between x₂ and x₃ so that the journey profile information transmitted to the following vehicle 5 comprises, according to the invention, a journey time between said vehicle's current position x=1701 and a position on the future journey route, for example the position of the end of the section. From this information, the receiving vehicle 5 determines a journey time, for example as far as the next end of a section. In the example, this journey time comprises forty-two seconds. The vehicle 5 which has received this journey profile information transmits, triggered by the reception, its journey profile information to the vehicle 4 following it. In addition, it transmits, as part of the journey profile information received by it, the journey time determined between its current position and the end of the section to the following vehicle 4.

The expenditure on communications between the vehicles is reduced as a result of the fact that the vehicles do not merely pass on the received journey profile information in a chain but instead each individual vehicle preferably processes the data and passes on the compressed information, that is to say the journey time which is determined or even the overall travel time between its current position and the end of the section, as part of the journey profile information received by the vehicle. Vehicle 4, for its part, then determines the journey time between its position and the vehicle traveling ahead from the received journey profile information. Said journey time is, for example, thirty seconds. Together, the journey time between the current vehicle position and the end of the section is therefore seventy-two seconds. This vehicle 4 and the following vehicles also transmit the respectively determined journey time as far as the end of the section as well as their own journey profile information to following vehicles. In this way, each following vehicle can determine a journey time for the route between its own current position and the next end of the section. The journey time determined according to the invention between the vehicle 1 at the bottom in the figure the end 7 of the section is two hundred and four seconds in the example illustrated in the figure. Known journey times for sections of the rest of the route or for various alternative routes, which have been determined for example in accordance with the method according to the invention, can also be passed on in the information chain. This is represented in the figure by the dotted arrow to the right of the figure.

FIG. 2 represents the recursive determination of the journey time when a journey information inquiry is transmitted by a vehicle, when determining a journey time up to the end of the next journey section. When the journey time is determined using bi-directional communication, the journey time is preferably calculated from the received position information, contained in the journey information inquiry, of the vehicle transmitting the position information, and from the journey profile data stored by the respective vehicle receiving the inquiry. In this preferred embodiment of the method according to the invention, each vehicle involved in the method calculates the journey time for the following vehicle in the sequence which has transmitted the journey information inquiry.

The figure shows a sequence of six vehicles 1 to 6 which are involved in a process of determining the journey time according to the invention, on a journey route 9. In the figure there are no further vehicles between vehicles involved in the determination of the journey time. This is generally not necessarily the case. The journey time can also be determined if further vehicles which do not communicate according to the invention travel between the vehicles involved. The journey profiles of the individual vehicles are represented in a travel/time diagram to the left of the illustration of the journey route. On the journey route there are two journey section boundaries 7, 8. To the right of the journey route, the procedure of communicating between the vehicles is illustrated in the figure. The journey profile information is always transferred in the direction of following vehicles by vehicles traveling ahead, i.e. is transferred to vehicles which are located upstream in the flow of traffic.

Vehicle 1 which is at the bottom of the figure transmits a journey information inquiry to the next vehicle 2 traveling ahead, in order to obtain the travel time for the route sections lying ahead of it—in the illustrated specific case, the journey time as far as the next route section boundary. Owing to the fact that a journey information inquiry takes place in the direction of travel to vehicles traveling ahead, i.e. in the direction of the flow of vehicles, that is to say downstream, and the transmission of journey profile information takes place upstream, i.e. backwards, the communication between the vehicles is bi-directional. The journey information inquiry includes the current vehicle position x of the vehicle transmitting the journey information inquiry. The vehicle position is given in the figure as a distance from a first journey section boundary which has just been reached. The bottommost vehicle 1 therefore passes on its position x=0 in its journey information inquiry in the figure. The receiving vehicle 2 traveling ahead can already determine the journey time between the position of the transmitting vehicle 1 and its own position x=340 from its own stored journey profile data. Said position is thirty-seven seconds in the example of the figure. In order to determine journey times for the route further downstream, the vehicles traveling ahead in the sequence pass on the journey information inquiry to the vehicle which is respectively traveling further ahead until the journey information inquiry has been received by a last vehicle which has already reached the next boundary of the travel section. In the figure, this is the uppermost vehicle 6. Here, the respective current vehicle position x of the vehicle passing on the journey information inquiry is transferred, along with the journey information inquiry, to the vehicle traveling ahead. The last vehicle 6 then starts to transmit the journey profile data to the vehicle 5 following behind it. The last vehicle 6 determines its own travel time, required between this position and the end of the section, from its own journey profile data and the position of the following vehicle x=1701 which has been transferred by the following vehicle 5 in the journey information inquiry. Said travel time is thirty-eight seconds in the example. The last vehicle 6 therefore transfers the travel time thirty-eight seconds using vehicle-to-vehicle communication to the following vehicle 5 which is involved in the execution of the method according to the invention. The latter knows the position of the vehicle 4 following it (x=1320) from the journey information interrogation of said vehicle. It in turn determines its own required travel time between its own position and the vehicle 4 following it from its own journey profile data. This travel time (twenty-nine seconds) is added to the travel time transferred by the vehicle traveling ahead. The result corresponds to the journey time between the following vehicle 4 and the boundary of the section. This result (sixty-seven seconds) is in turn transferred to the following vehicle 3 using vehicle-to-vehicle communication. This determination of the travel time is continued until the journey profile data has been transferred to the vehicle 1 which has originally started the journey profile information inquiry. This vehicle receives in this way a current journey time which has been determined from the journey profile data of the vehicles traveling ahead. In the example, the journey time, determined according to the invention, between the position of the vehicle 1 which originally started the journey profile information inquiry and the end of the section is one hundred and eighty-nine seconds. In the way illustrated, a journey time to any desired destination can also be determined. To do this, the desired destination is transferred along with the journey profile inquiries and the journey time calculation is carried out as far as this destination, instead of as far as the end of the section.

A vehicle preferably starts to transmit back the journey profile information even if the vehicle determines that there is no further vehicle traveling ahead within the range of the means of the vehicle-to-vehicle communication. Here, a message which provides information on the breaking of the transmission chain is also preferably transmitted.

Known journey times for sections of the rest of the route or for various alternative routes which, for example, have been determined according to the inventive method, can also be passed on in the information chain. This is illustrated in the figure using the dotted arrow on the right of the figure.

1-13. (canceled)

14. A method for determining a journey time for a journey route for a following vehicle traveling in a sequence of vehicles, the method comprising the steps of:
collecting journey profile data by a vehicle traveling ahead in the sequence, the journey profile data including at least a travel time or data permitting determination of the travel time for a route component between a first and a second position on the journey route;
calculating a journey time in the vehicle collecting the journey profile data for a route including the route component from the journey profile data; and
transmitting journey profile information including the journey time or the journey profile data using vehicle-to-vehicle communication from the vehicle traveling ahead to a receiving following vehicle.

15. The method as recited in claim 14 wherein the second position is the current position of the following vehicle and the first position is a location on the journey route ahead of the following vehicle.

16. The method as recited in claim 14 wherein the first and second positions have fixed distances.

17. The method as recited in claim 14 wherein the receiving following vehicle calculates a further journey time as a function of the journey time and a travel time of the receiving following vehicle over a second route component, and transmits the further journey time to a further following vehicle.

18. The method as recited in claim 14 wherein the journey profile information transferred to the receiving following vehicle is restricted to a specific radius around the transmitting or receiving vehicles.

19. The method as recited in claim 19 wherein the radius is determined by chronological accessibility.

20. The method as recited in claim 14 wherein the journey time is an overall journey time including the travel time and a further journey time received from another vehicle traveling ahead in the sequence.

21. The method as recited in claim 14 wherein the transmission of the journey profile information by the vehicle traveling ahead is triggered by predefined journey section boundaries being reached and/or by reception of other journey profile information of another vehicle traveling ahead.

22. The method as recited in claim 14 wherein the transmission of the journey profile information by the vehicle traveling ahead is triggered by reception of a journey information inquiry.

23. The method as recited in claim 22 wherein the journey information inquiry is transmitted by one vehicle to the vehicle traveling ahead in the sequence, and the vehicle traveling ahead in the sequence transfers the journey information inquiry to a further vehicle traveling ahead, this step being repeated until the journey information inquiry has been transferred to a frontmost vehicle traveling ahead, the frontmost vehicle traveling ahead having already reached a destination specified in the journey information inquiry or having already reached a next journey section boundary.

24. The method as recited in claim 23 wherein the journey information inquiry contains a current vehicle position of the vehicle transmitting the journey information inquiry, and the journey profile information transferred to at least one following vehicle comprises an overall travel time between the current vehicle position and the destination or the journey section boundary, the overall travel time being calculated by summing travel times transmitted back, from the frontmost vehicle traveling ahead, to the vehicles involved in the passing-on of the journey information inquiry.

25. The method as recited in claim 14 wherein journey times are determined for at least two alternative journey routes, an optimum journey route being determined by selecting the alternative journey route having a shortest journey time.

26. A method for determining a journey time for a journey route for a following vehicle traveling in a sequence of vehicles, a first vehicle in the sequence of vehicles traveling a first travel time for a first route component on the journey route, the method comprising the steps of:
receiving the first travel time from the first vehicle at a second vehicle following the first vehicle;
calculating at the second vehicle a first journey time for the second vehicle as a function of the first travel time;
determining at the second vehicle a second travel time of the second vehicle over a second route component on the journey route; and
transmitting the first journey time for the second vehicle and the second travel time from the second vehicle to a third vehicle.

27. The method as recited in claim 26 wherein the third vehicle calculates a further journey time using the first journey time for the second vehicle and the second travel time.
